(19) United States
(12) Patent Application Publication
(10) Pub. No.: US 2026/0004463 A1
(43) Pub. Date: Jan. 1, 2026

(54) IMAGE ENCODING METHOD AND DECODING METHOD

(71) Applicant: Lenovo (Beijing) Limited, Beijing (CN)

(72) Inventor: Tao YANG, Beijing (CN)

(21) Appl. No.: 19/251,761

(22) Filed: Jun. 26, 2025

(30) Foreign Application Priority Data
Jun. 28, 2024 (CN) 202410870194.4

(51) Int. Cl. G06T 9/00; G06F 40/12; G06T 7/10

(52) U.S. Cl. CPC G06T 9/00; G06F 40/12; G06T 7/10; G06T 2207/20021

(57) ABSTRACT

An image encoding method includes dividing an input image into a plurality of image areas according to a preset division mode, converting the plurality of image areas into a plurality of pieces of semantic text data based on a first conversion module, and packaging the plurality of pieces of semantic text data to generate encoded data of the input image. Each piece of semantic text data represents semantics describing a corresponding image area.

### CROSS-REFERENCE TO RELATED APPLICATION

The present disclosure claims priority to Chinese Patent Application No. 202410870194.4, filed on Jun. 28, 2024, the entire content of which is incorporated herein by reference.

### TECHNICAL FIELD

The present disclosure relates to the encoding and decoding technology field and, more particularly, to an image encoding method and an image decoding method.

### BACKGROUND

Image compression is generally achieved by using a mature algorithm to remove low-frequency redundant data in a spatial domain, such as JPEG, etc. Although such an algorithm is relatively mature and stable, a compression rate is limited by characteristics of the algorithm. Often, the compression rate of the image is not high, and the amount of data is still large after the compression.

### SUMMARY

An aspect of the present disclosure provides an image encoding method. The method includes dividing an input image into a plurality of image areas according to a preset division mode, converting the plurality of image areas into a plurality of pieces of semantic text data based on a first conversion module, and packaging the plurality of pieces of semantic text data to generate encoded data of the input image. Each piece of semantic text data represents semantics describing a corresponding image area.

An aspect of the present disclosure provides a decoding method. The method includes obtaining encoded data of an input image, converting the plurality of pieces of semantic text data into a plurality of pieces of image area data corresponding to the plurality of image areas based on a third conversion module, and combining the plurality of pieces of image area data to obtain decoded input image data. The encoded data includes a plurality of pieces of semantic text data corresponding to a plurality of image areas.

An aspect of the present disclosure provides an electronic device, including one or more processors and one or more memories. The one or more memories store a program that, when executed by the one or more processors, causes the one or more processors to divide an input image into a plurality of image areas according to a preset division mode, convert the plurality of image areas into a plurality of pieces of semantic text data based on a first conversion module, and package the plurality of pieces of semantic text data to generate encoded data of the input image. Each piece of semantic text data represents semantics describing a corresponding image area.

### BRIEF DESCRIPTION OF THE DRAWINGS

FIG. 1 illustrates a schematic flowchart of an image encoding method according to some embodiments of the present disclosure.

FIG. 2 illustrates a schematic flowchart of step S200 in FIG. 1 according to some embodiments of the present disclosure.

FIG. 3 illustrates a schematic flowchart of step S230 in FIG. 2 according to some embodiments of the present disclosure.

FIG. 4 illustrates a schematic flowchart of another image encoding method according to some embodiments of the present disclosure.

FIG. 5 illustrates a schematic flowchart of step 1200 in FIG. 1 according to some embodiments of the present disclosure.

FIG. 6 illustrates a schematic flowchart of step S230 in FIG. 2 according to some embodiments of the present disclosure.

FIG. 7 illustrates a schematic flowchart of an image decoding method according to some embodiments of the present disclosure.

FIG. 8 illustrates a schematic structural diagram of an encoder according to some embodiments of the present disclosure.

FIG. 9 illustrates a schematic structural diagram of a decoder according to some embodiments of the present disclosure.

### DETAILED DESCRIPTION OF THE EMBODIMENTS

Various solutions and features of the present disclosure are described with reference to the accompanying drawings.

Various modifications can be made to embodiments of the present disclosure. Thus, the above description should not be considered as limiting, but merely as exemplary embodiments. Those skilled in the art can think of other modifications within the scope and spirit of the present disclosure.

The accompanying drawings, which are incorporated in and form a part of the specification, illustrate embodiments of the present disclosure and, together with the general description of the present disclosure given above and the detailed description of the embodiments given below, are used to explain the principles of the present disclosure.

These and other characteristics of the present disclosure will become apparent through the following description of preferred embodiments, which are considered non-limiting examples with reference to the accompanying drawings.

Although the present disclosure has been described with reference to some specific examples, those skilled in the art can certainly implement many other equivalent forms of the present disclosure.

When considered in conjunction with the accompanying drawings, the above and other aspects, features, and advantages of the present disclosure will become more apparent from the following detailed description.

Specific embodiments of the present disclosure are described below with reference to the accompanying drawings. However, the described embodiments are merely examples of the present disclosure, which can be implemented in various ways. Well-known and/or repetitive functions and structures are not described in detail to avoid unnecessary or redundant details that may obscure the present disclosure. Therefore, the specific structural and functional details of the present disclosure are not intended to be limiting but serve as a basis and representative foundation for the claims to teach those skilled in the art to use the present disclosure in any appropriately detailed structure.

Phrases such as “in one embodiment,” “in another embodiment,” “in yet another embodiment,” or “in other embodiments,” can be used in the specification and can all refer to one or more of the same or different embodiments according to the present disclosure.

To address the problems in the background technology, embodiments of the present disclosure provide an image encoding method for image encoding.

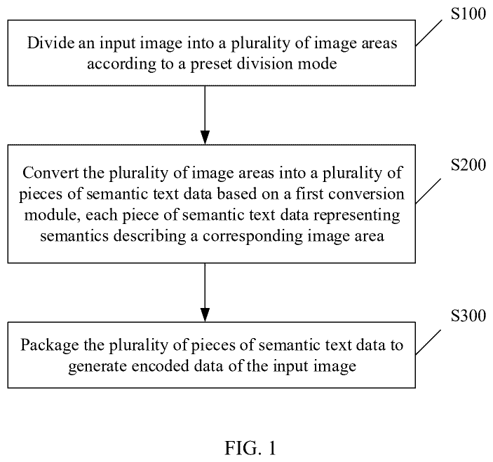

The image encoding method is described in detail below with reference to the accompanying drawings. FIG. 1 illustrates a schematic flowchart of an image encoding method according to some embodiments of the present disclosure. As shown in FIG. 1, the method includes the following steps.

At S100, an input image is divided into a plurality of image areas according to a preset division mode.

For example, an image that needs to be encoded can be determined first. Then, the determined image that needs to be encoded can be input into a preset division module. The preset division module can have a preset division mode. The preset division module can be configured to divide the input image through the preset division mode. For example, the input image can be divided into a plurality of image areas. The plurality of image areas can be independent of each other or can have overlapped parts among the image areas. In some other embodiments, one image area can be a subarea of another image area.

The relationships between the plurality of divided image areas can be different according to different division modes. For example, the preset division mode can include, but is not limited to, a semantic segmentation mode. Semantic segmentation can be performed on the image according to category labels, such as “road,” “vehicle,” “pedestrian,” and “sky.” Semantic segmentation can be performed to segment and output the image using a fully convolutional network (FCN), U-Net Convolutional Networks for Biomedical Image Segmentation (U-Net), Semantic Image Segmentation with Deep Convolutional Nets, Atrous Convolution, and Fully Connected CRFs (DeepLab), or a Mask Region-based Convolutional Neural Network (Mask R-CNN). Semantic segmentation can include assigning a predefined category label to each pixel in the image to realize image understanding in the pixel level. Unlike image classification (which identifies only the category of the entire image) and object detection (which identifies the location and category of objects in the image), semantic segmentation can categorize each pixel and can provide finer image understanding. The preset division mode can also employ other division methods to divide the input image, which is merely exemplary and does not limit the scope of claims.

At S200, the plurality of image areas are converted into a plurality of pieces of semantic text data based on a first conversion module. Each piece of semantic text data represents semantics describing the corresponding image area.

For example, the plurality of image areas can be input into the first conversion module simultaneously or one by one, or the first conversion module can actively obtain the plurality of divided image areas, and convert the plurality of image areas into the plurality of pieces of semantic text data simultaneously or sequentially.

For example, the plurality of image areas can be input into the first conversion module simultaneously. The first conversion module can be configured to convert the plurality of image areas simultaneously by using a plurality of sub-conversion modules. Each image area can correspond to one sub-conversion module, and each sub-conversion module can convert one image area. During the conversion, a plurality of pieces of semantic text data can be generated simultaneously for the corresponding image areas. Alternatively, the plurality of image areas can be input into the first conversion module simultaneously, and the first conversion module can be configured to convert the plurality of image areas one by one. One piece of semantic text data can be generated each time an image area is generated. Regardless of which the conversion method is used, each piece of semantic text data can be represented as the semantics describing the corresponding image area.

The first conversion module can, but is not limited to, be based on an artificial intelligence (AI) image-to-text algorithm. The divided image areas can be automatically converted into the semantic text data through AI. The AI image-to-text algorithm can be an algorithm that combines computer vision and natural language processing (NLP) technologies, and can generate a corresponding textual description based on the input image. When the AI image-to-text algorithm converts the divided image areas into semantic text data, the AI image-to-text algorithm can preprocess the image areas, including performing necessary preprocessing operations such as scaling, cropping, and denoising, on the input image areas to improve the accuracy and efficiency of subsequent processing. Then, feature extraction can be performed. For example, the feature extraction can be performed on the image using a deep learning model to obtain high-level representations of the image. These features can include information such as object shapes, colors, and textures. Then, semantic text can be generated, including generating textural descriptions related to the image content using a natural language generation module based on the extracted image features. Subsequently, post-processing operations can be performed on the generated semantic text data, e.g., grammar checks and fluency optimization, to improve the quality and readability of the text.

The plurality of divided image areas can be converted into the semantic text data corresponding to the plurality of image areas one-to-one through the first conversion module.

The amount of data of the text data can be much smaller than the amount of data of the image areas. Thus, the amount of data can be significantly reduced when the image areas are converted into the corresponding semantic text data.

At S300, the plurality of pieces of semantic text data are packaged to generate encoded data for the input image.

For example, the semantic text data generated in step S200 can be scattered and independent. All semantic text data corresponding to the divided image areas can be packaged to generate encoded data corresponding to the input image before the division. The encoded data of the input image obtained through the above method can be used to improve the compression rate of the input image. That is, the large image data can be converted into text information with a small amount of data. Thus, the space required for storage can be reduced. When the data transfer is performed through the networks, the time consumed by the transmission can be reduced.

In embodiments of the present disclosure, by dividing the input image into a plurality of image areas, and converting each image area into the semantic text data corresponding to each image area through the image conversion module, the plurality of pieces of semantic text data can be packaged to generate the encoded data of the input image. Thus, the large image data can be converted into the text information with a small amount of data. The space required for storage can be reduced, and the time consumed for transmission can be reduced when the data transmission is performed through the networks.

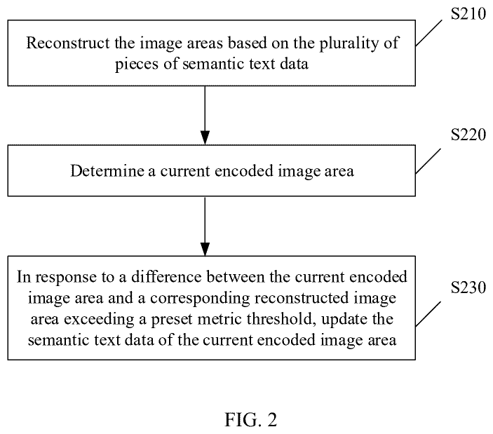

In some embodiments, as shown in FIG. 2, the method further includes the following steps.

At S210, the image areas are reconstructed based on the plurality of pieces of semantic text data.

For example, before packaging the plurality of pieces of semantic text data to generate the encoded data to generate the input image, that is, after the first conversion module converts the plurality of image areas into the plurality of pieces of semantic text data, the image areas can be reconstructed based on the plurality of pieces of semantic text data. One image area can be reconstructed for each piece of semantic text data. The reconstructed image areas can be identical or highly similar to the image areas obtained by dividing the input image in the preset division mode, or the reconstructed image areas can have significant differences from the image areas obtained by dividing the input image.

If the reconstructed image areas are identical or highly similar to the image areas obtained by dividing the input image in the preset division mode, the semantic text data generated by the first conversion module based on the plurality of divided image areas can accurately or almost accurately describe the divided image areas. However, if the reconstructed image areas have a significant difference from the image areas obtained by dividing the input image in the preset division mode, the semantic text data generated by the first conversion module based on the plurality of divided image areas cannot describe or cannot accurately describe the divided image areas. Thus, the semantic text data generated by the first conversion module based on the plurality of divided image areas can have errors.

At S220, the current encoded image area is determined.

For example, to determine the similarity between the reconstructed image areas and the image areas obtained by dividing the input image in the preset division mode, the current encoded image area may need to be determined after the image areas are reconstructed. Then, the determined current encoded image area can be compared with the reconstructed areas. The current encoded image area can be an image area obtained by dividing the input image in the preset division mode after the semantic text conversion.

At S230, if the difference between the current encoded image area and the corresponding reconstructed image area exceeds a preset metric threshold, the semantic text data of the current encoded image area is updated.

For example, the current encoded image area can be compared with the corresponding reconstructed image area. If the difference between the current encoded image area and the corresponding reconstructed image area exceeds the preset metric threshold, the image reconstructed based on the semantic text data cannot accurately reflect the current encoded image area. The semantic text data corresponding to the current encoded image area may be inaccurate. Thus, the semantic text data of the current encoded image area can be updated.

The preset metric threshold can be set according to the actual requirements of the user. For example, the present metric threshold can be set to 3% or 5%, or other values. When the difference between the current encoded image area and the corresponding reconstructed image area exceeds 3% or 5%, the semantic text data of the current encoded image area may need to be updated to ensure the accuracy of the description of the updated semantic text data for the current encoded image area to meet the requirements of the preset metric threshold.

Updating the semantic text data of the current encoded image area can be a single update or a plurality of iterative updates to allow the description accuracy of the updated semantic text data for the current encoded image area to meet the preset metric threshold.

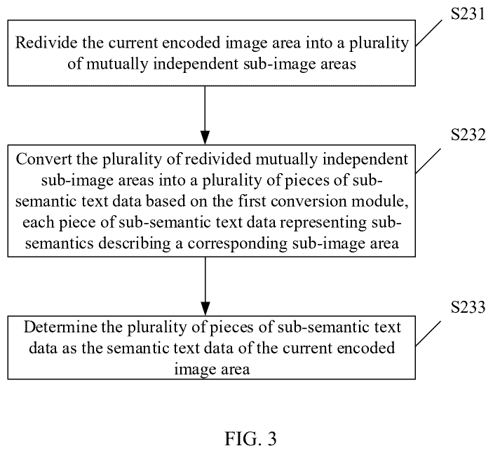

In some embodiments, with reference to FIG. 3, updating the semantic text data of the current encoded image area includes the following steps.

At S231, the current encoded image area is redivided into a plurality of mutually independent sub-image areas.

For example, when the semantic text data of the current encoded image area is insufficient to accurately describe the current encoded image area, a part of the semantic text data of the current encoded image area may fail to accurately describe one or more small sub-image areas of the current encoded image area, and can accurately describe other parts of the current encoded image area. Therefore, by dividing the current encoded image area into smaller sub-image areas relative to the current encoded image area, when the semantic text conversion is performed on the sub-image areas subsequently, areas of the current encoded image areas without obtaining an accurate semantic description can be more accurately determined.

The divided sub-image areas can be mutually independent. For instance, the current encoded image area can be divided into a first sub-image area and a second sub-image area. The combination of the first sub-image area and the second sub-image area can form the entire current encoded image area. However, the first sub-image area and the second sub-image area may not have an overlapped part. The current encoded image area can be divided into mutually independent sub-image areas to prevent the sub-image areas from partially or fully overlapping with each other. Thus, when the semantic text data conversion is subsequently performed on the sub-image areas, a more independent semantic text data conversion can be performed on each of the mutually independent sub-image areas. That is, the first sub-semantic text data corresponding to the first sub-image area can only be represented as describing the first sub-image area without including the semantic description of the second sub-image area. Similarly, the second sub-semantic text data may also not include the semantic text of the first sub-image area to avoid the difference in the descriptions of the first sub-semantic text data and the second sub-semantic text data in the overlapped part between the first sub-image area and the second sub-image area to impact the description accuracy of the first sub-image area and the second sub-image area. That is, mutual impacts between different pieces of sub-semantic text data can be avoided to impact the subsequent packaging result of the semantic text. Thus, the packaged semantic text data can more accurately describe the sub-image area.

In one embodiment, if the current encoded image area includes a plurality of color blocks, and each color block has a distinct color, the current encoded image area can be re-divided into a plurality of mutually independent sub-image areas according to the color blocks. Each sub-image area can correspond to one color block.

At 232, based on the first conversion module, the plurality of re-divided mutually independent sub-image areas are converted into a plurality of pieces of sub-semantic text data. Each piece of sub-semantic text data represents the sub-semantic description of the corresponding sub-image area.

For example, the plurality of re-divided mutually independent sub-image areas can be input into the first conversion module, or the first conversion module can actively obtain he plurality of re-divided mutually independent sub-image areas. In connection with the above embodiments, the first sub-image area and the second sub-image area that are independent of each other can be input into the first conversion module. Then, the first conversion module can be configured to convert the redivided first sub-image area and the second sub-image area into the first sub-semantic text data and the second sub-semantic text data. The first sub-semantic text data and the second sub-semantic text data can represent the semantics corresponding to the first sub-image area and the second sub-image area, respectively. The first sub-semantic text data and the second sub-semantic text data can also be independent of each other.

The method for converting, by the first conversion module, the sub-image areas into the sub-semantic text data can be the same as the method for converting, by the first conversion module, the divided input image areas of the input image into the semantic text data, which is not be repeated here.

At S233, the plurality of pieces of sub-semantic text data are determined as the semantic text data of the current encoded image area.

For example, in connection with the above embodiment, the first sub-semantic text data and the second sub-semantic text data can be determined as the semantic text data of the current encoded image area. The semantic text data can be the updated semantic text data representing the current encoded image area. Then, the semantic text data of the current encoded image area may have been updated once. The number of times of updating the semantic text data of the current encoded image area can be determined according to whether the updated semantic text data satisfies the description accuracy of the current encoded image area. That is, when the difference between the current encoded image area and the corresponding reconstructed image area is smaller than or equal to the preset metric threshold, the semantic text data of the current encoded image area may not be iteratively updated.

In some embodiments, updating the semantic text data of the current encoded image area can include determining a neighboring area of the current encoded image area and modifying the semantic text data of the current encoded image area based on the semantic text data of the neighboring area.

For example, the current encoded image area can have at least one neighboring area. If the semantic text data of the current encoded image area fails to meet the description requirements of the current encoded image area, the semantic text data corresponding to the boundary position in the previous encoded image area may not be accurate enough. Thus, the semantic text data of the previous encoded image area can be adjusted according to the semantic text data of the area that is neighboring to the current encoded image area.

For instance, if the current encoded image area is the first area, a second area that is neighboring to the first area can surround the periphery of the first area. The first area that is neighboring to the second area can include a part of the boundary of the first area that overlaps with a part of the boundary of the second area. When the semantic text data of the first area is updated, the semantic text data of the first area can be modified according to the semantic text data of a partial area of the second area overlapping with the outer boundary of the first area and extending into the second area.

In some embodiments, the current encoded image area can be a neighboring area, which can be a neighboring area in any direction (e.g., up, down, left, and right) relative to the current encoded image area.

In some embodiments, the image corresponding to the current encoded image area can show a dog wearing glasses on the beach looking at the sun. However, since the current encoded image area does not clearly indicate whether the sunlight is from the sunrise or the sunset, the output semantic text can be “a dog wearing glasses on the beach looking at the sun.” When the neighboring encoded image area to the right of the current encoded image area outputs the semantic text “sunset,” the semantic text of the current encoded image area can be modified to Therefore, the semantic text of the current “a dog wearing glasses on the beach looking at the sunset” according to the neighboring encoded image area.

In some other embodiments, the semantic text data of the current encoded image area can be regenerated based on the second conversion module. The second conversion module can have different model parameters from the first conversion module.

For example, another conversion module can be configured to regenerate the semantic text data of the current encoded image area. The another conversion module can be the second conversion module. The second conversion module can have different model parameters from the first conversion module. In some embodiments, different model parameters can refer to the generated key model parameters corresponding to the semantic text data. The key model parameters can be set to directly affect the description accuracy of the semantic text data to the current encoded image area. In some embodiments, the bottom models of the first conversion model and the second conversion model can be different. For example, one conversion model can be based on a Transformer model, and the other conversion model can be based on a Diffusion model. In some embodiments, models of the first conversion module and the second conversion module can be used for different styles. For example, one conversion module can be mainly used for human description conversion, and the other conversion module can be mainly used for scenery description conversion. Thus, when the second conversion module has the model parameters different from the first conversion module to regenerate the semantic text data of the current encoded image area, the regenerated semantic text data can be different from the semantic text data of the current encoded image area generated by the first conversion module.

The semantic text data can be converted for the current encoded image area according to the type of the current encoded image area. For example, the current encoded image area can include a car and a person leaning against the car. The color of the person can be similar to the color of the car. Then, in step S234, the car can be used as the first sub-image area, and the person can be used as the second sub-image area for division. Based on the semantic text data of the boundary area where the person overlaps with the car, the semantic text of the current encoded image area can be modified. When the current encoded image area corresponds to several green leaves of a tree, that is, when the whole current encoded image area is consistent with a plurality of green leaves with similar colors, the current encoded image area cannot be divided into distinct blocks. With step S234, a poor effect may be obtained for updating the semantic text data. Then, the semantic text data can be updated in step S235.

In some embodiments, the preset division mode can include a first mode, a second mode, and a third mode.

In the first mode, the plurality of image areas can be mutually independent. In connection with the above embodiments, if the input image includes a plurality of color blocks with no overlap, and each color block has a distinct color, the input image can be divided into a plurality of mutually independent image areas in the first mode.

In the second mode, the plurality of image areas can include a first area and a second area. The first area can include the second area. For example, the input image can include a person. A label having a color different from the color of the face of the person can be attached to the face of the person. The input image can be divided into a plurality of image areas in the second mode. The plurality of image areas can include the first area of the face of the person and the second area of the label on the face of the person.

In the third mode, the plurality of image areas can include a first area and a second area. The first area and the second region can partially overlap. In connection with the above embodiments, if the input image includes a car and a person leaning against the car, the input image can be divided into a plurality of image areas in the third mode. The plurality of image areas can include the first area formed by the car and a corresponding part of the person. The corresponding part of the person can be a part of the person that blocks the car. The second area can be the area where the person is located.

Of course, the input image can be divided in any one or more of the first mode, the second mode, or the third mode of the preset division mode. For example, the input image can include a person. A label having a color different from the color of the face of the person can be attached to the face of the person. The label can include a plurality of color modules. The color modules do not overlap. Each color module can have a distinct color. Thus, the input image can be divided in the first mode and the second mode.

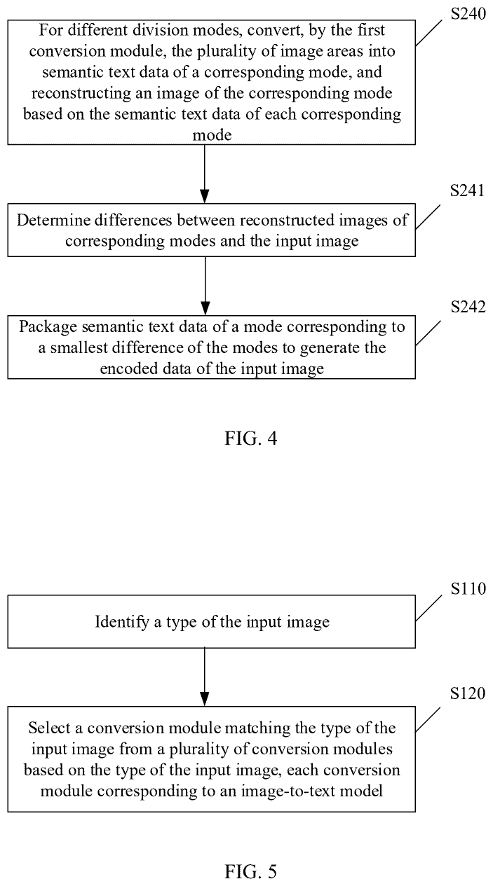

In some embodiments, as shown in FIG. 4, converting the plurality of image areas into the plurality of pieces of semantic text data based on the first conversion module includes the following processes.

At S240, for different division modes, the first conversion module converts the plurality of image areas into semantic text data of the corresponding modes. Based on the semantic text data of each corresponding mode, the image of the corresponding mode is reconstructed.

For example, since the input image is divided into a plurality of different image areas in different division modes, the plurality of image areas can be mutually independent or partially overlapped, or one image area can include another image area. Thus, the first conversion module can perform semantic text data conversion accordingly. For example, for the above first mode, the second mode, and the third mode, the first conversion module can convert the plurality of image areas into semantic text data corresponding to the first mode, the second mode, or the third mode. Then, based on the semantic text data of the first mode, the second mode, and the third mode, the images corresponding to the first mode, the second mode, and the third mode can be reconstructed.

At S241, the differences between the reconstructed images corresponding to the modes and the input image are determined.

For example, after reconstructing the images corresponding to the first mode, the second mode, and the third mode, the reconstructed images can be compared with the input images in the first mode, the second mode, and the third mode to determine the similarity between the reconstructed images corresponding to the first mode, the second mode, and the third mode and the input images of the corresponding modes. For different division modes, the reconstructed image can have different similarities with the input image in the corresponding mode.

At S242, the semantic text data corresponding to a mode with the smallest difference among the modes is packaged to generate the encoded data of the input image.

For example, in connection with the above embodiments, the input image can include the car and the person leaning against the car. If the image area division is performed in the first mode, the similarity between the reconstructed image corresponding to the first mode and the input image can be 95%. If the image area division is performed in the second mode, the similarity between the reconstructed image corresponding to the first mode and the input image can be 97%. If the image area division is performed in the third mode, the similarity between the reconstructed image corresponding to the first mode and the input image can be 98%. Then, the semantic text data generated corresponding to the third mode can be packaged to generate the encoded data of the input image. In some embodiments, the encoded data generated by packaging the semantic text data of the third mode can be more accurate and can more accurately describe the divided image area of the input image. Thus, the encoded data can be more beneficial for restoring the input image.

In some embodiments, as shown in FIG. 5, before dividing the input image, the method further includes the following steps.

At S110, the type of the input image is identified.

For example, before dividing the input image, the type of the input image can first be determined. Then, when the input image is subsequently divided, the input image can be divided into a plurality of image areas that are more suitable for accurately performing the semantic text data conversion according to the type of the input image.

When the type of the input image is identified, the image can be pre-processed, e.g., resizing and normalization, to ensure data consistency and processability. Feature extraction can then be applied to the preprocessed input image. For example, a classification model (e.g., support vector machines, random forests, or neural networks) can be applied for training to distinguish color block images and images with similar colors to determine the type of the input image.

At S120, a conversion module matching the type of the input image is selected from the plurality of conversion modules based on the type of the input image. Each conversion module corresponds to an image-to-text model.

For example, in connection with the above embodiments, if the type of the input image is determined to include the car and the person leaning against the car, and the person and the car have similar colors, the first conversion module can be configured to divide the car into the first image area and the person into the second image area. The overlapping part of the person and the car can be divided into the first image area and the second image area. Then, the conversion module matching the type of the input image can be applied. The conversion module can include, but is not limited to, the first conversion module. The first image area and the second image area can be converted into the semantic text data corresponding to the first image area and the second image area through the first conversion module, respectively. The first conversion module can include a corresponding first image-to-text model.

When the input image consists of green leaves of several trees, i.e., the whole current encoded image area consists of a plurality of green leaves with similar colors, the current encoded image area cannot be properly divided into distinct blocks. If the first conversion module is not able to obtain the semantic text data accurately describing the input image, the input image can be converted into the corresponding semantic text data in the second conversion module. The second conversion module can include the corresponding second image-to-text model. The model parameters of the second image-to-text model can be different from the model parameters of the first image-to-text model.

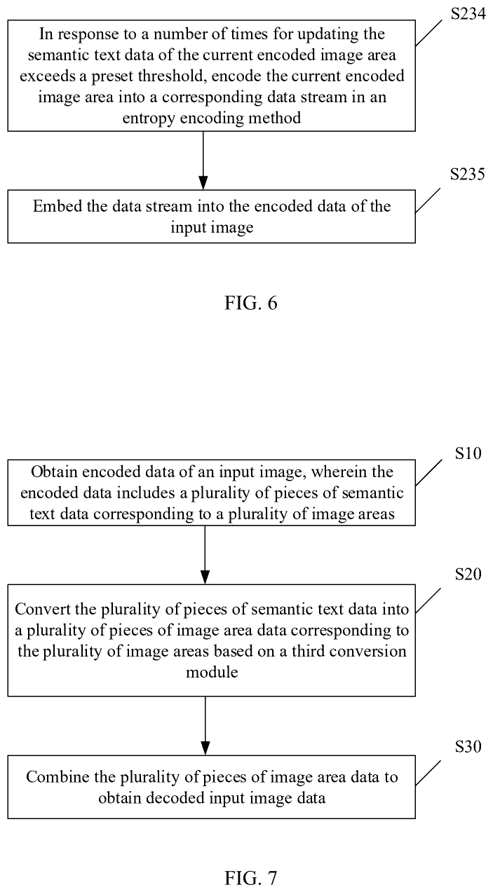

In some embodiments, as shown in FIG. 6, the method further includes the following steps.

At S234, when a number of times for updating the semantic text data of the current encoded image area exceeds a preset threshold, the current encoded image area is encoded into a corresponding data stream in an entropy encoding method.

For example, after the semantic text data of the current encoded image area is updated for a plurality of times, if the updated semantic text data still does not satisfy the description similarity requirement for the current encoded image area, and the number of times for updating the semantic text data exceeds the preset threshold, the updated semantic text data still cannot satisfy the description similarity requirement for the current encoded image area even the semantic text data of the current encoded image area is continued to be updated. The currently applied conversion module may no longer be used, and a conventional encoding method can be applied to encode the current encoded image area. For example, the current encoded image area can be encoded into the corresponding data stream in an entropy encoding method. In some embodiments, for example, the current encoded image area can be compressed in an image compression system, e.g., in a JPEG format, or a GIF format. In some other embodiments, the current encoded image area can be encoded and compressed into other formats in the entropy encoding method. The preset threshold can be adjusted as needed. For example, the preset threshold can be set to 10, 12, or another number set according to the user needs. The above is exemplary and does not limit the scope of the present disclosure.

At S235, the data stream is embedded into the encoded data of the input image.

For example, if four current encoded image areas are provided, and the number of times for correspondingly updating the semantic text data of one of the four current encoded image area exceeds the preset threshold, the current encoded image area can be encoded into the corresponding data stream in the entropy encoding method to ensure the corresponding data stream obtained by encoding the current encoded image area in the entropy encoding method can accurately reflect the current encoded image area. The other three current encoded image areas can still be converted into the corresponding three pieces of semantic text data. The data stream encoded in the entropy encoding method can be embedded into the three pieces of semantic text data. Thus, the encoded data corresponding to the four current encoded image areas can accurately reflect the current encoded image areas corresponding to the encoded data.

Based on the same inventive concept and as shown in FIG. 7, embodiments of the present disclosure further provide a decoding method, including the following steps.

At S10, the encoded data of the input image is obtained. The encoded data includes a plurality of pieces of semantic text data corresponding to the plurality of image areas.

For example, a decoder can actively obtain the encoded data of the input image, or the encoded data of the input image can be input into the decoder. The encoded data can include the plurality of pieces of semantic text data corresponding to the plurality of image areas obtained by dividing the input image. The plurality of pieces of semantic text data can represent the semantics describing the plurality of image areas.

At S20, based on a third conversion module, the plurality of pieces of semantic text data are converted into the plurality of pieces of image area data corresponding to the plurality of image areas.

For example, the decoder can include a third conversion module. The third conversion module can employ a conversion module corresponding to the text-to-image model. The text-to-image model can use an AI text-to-image model to convert the plurality of pieces of semantic text data into the plurality of pieces of image area data corresponding to the plurality of image areas. The third conversion module can be configured to convert the plurality of pieces of semantic text data into the plurality of pieces of image area data corresponding to the plurality of image areas. The third conversion module can perform conversion on the plurality of pieces of the semantic text data simultaneously or in sequence to obtain the plurality of pieces of image area data corresponding to the plurality of image areas.

At S30, the plurality of pieces of image area data are combined to obtain decoded input image data.

For example, the plurality of pieces of image area data converted in step S20 can be combined to form the decoded input image data. The decoded input image area can correspond to the input image.

In some embodiments, the method can further include identifying the image type in the decoded input image data and selecting a conversion module matching the image type from the plurality of conversion modules based on the image type. Each conversion module can correspond to a text-to-image model.

Before converting the decoded input image data using the conversion module, the image type in the decoded input image data can first be identified. For example, during the encoding phase, a marker indicating the image type of the input image can be provided in the encoded data of the corresponding input image. During decoding, the image type marker of the input image can be read first. Then, based on the image type marker of the input image, the conversion module matching the image type can be selected from the plurality of conversion modules. Thus, through the conversion of the matching conversion module, the image area data that can more accurately reflect the corresponding semantic text data can be obtained. Each conversion module can correspond to a text-to-image model. The model parameters of the text-to-image model corresponding to different conversion modules can be different.

For example, the image type in the decoded input image data can represent that the input image includes the plurality of color blocks without overlapping. Each color block can have a distinct color. Marker 1, representing the input image type, can be read from the input image encoded data. Corresponding to the input image type labeled by “1,” the fourth conversion module can be configured to convert the plurality of pieces of semantic text data corresponding to the encoded data of the input image into the plurality of pieces of image area data corresponding to the plurality of image areas. For another example, the image type of the decoded input image data can represent that the input image includes a person, and a label having a color different from the color of the face of the person is attached to the face of the person. Marker 2, representing the type of the input image, can be read from the input image encoded data. Corresponding to the input image type marked as “2,” the fifth conversion module can be configured to convert the plurality of pieces of semantic text data corresponding to the input image encoded data into the plurality of pieces of the image area data corresponding to the plurality of image areas. The fifth conversion module and the fourth conversion module can have different model parameters.

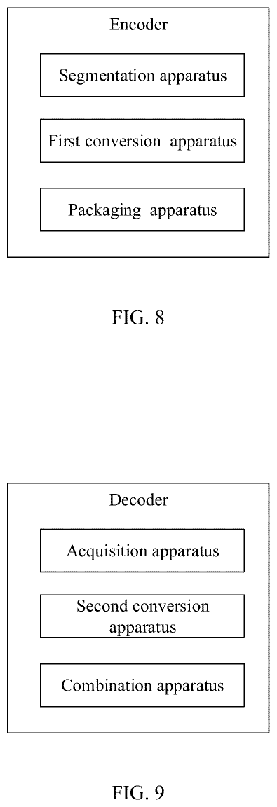

Based on the same inventive concept, the present disclosure further provides an encoder. As shown in FIG. 8, the encoder includes a segmentation apparatus, a first conversion apparatus, and a packaging apparatus.

The segmentation apparatus can be configured to divide the input image into a plurality of image areas according to a preset division mode.

The first conversion apparatus can be configured to convert the plurality of image areas into a plurality of pieces of semantic text data. Each piece of semantic text data can represent the semantics describing the corresponding image area.

The packaging apparatus can be configured to package the plurality of pieces of semantic text data to generate the encoded data of the input image.

Based on the same inventive concept, the present disclosure further provides a decoder. As shown in FIG. 9, the decoder includes an acquisition apparatus, a second conversion apparatus, and a combination apparatus.

The acquisition apparatus can be configured to obtain the encoded data of the input image. The encoded data can include the plurality of pieces of semantic text data corresponding to the plurality of image areas.

The second conversion apparatus can be configured to convert the plurality of pieces of semantic text data into the plurality of pieces of image area data corresponding to the plurality of image areas.

The combination apparatus can be configured to combine the plurality of pieces of image area data to obtain the decoded input image data.

The above provides a detailed description of embodiments of the present disclosure. However, the present disclosure is not limited to these specific embodiments. Those skilled in the art, based on the concepts of the present disclosure, can make various modifications and variations. These modifications and variations should be within the scope of the present disclosure.

What is claimed is:

1. An image encoding method comprising:
dividing an input image into a plurality of image areas according to a preset division mode;
converting the plurality of image areas into a plurality of pieces of semantic text data based on a first conversion module, wherein each piece of semantic text data represents semantics describing a corresponding image area; and
packaging the plurality of pieces of semantic text data to generate encoded data of the input image.

2. The image encoding method according to claim 1, further comprising:
reconstructing the image areas based on the plurality of pieces of semantic text data;
determining a current encoded image area; and
in response to a difference between the current encoded image area and a corresponding reconstructed image area exceeding a preset metric threshold, updating the semantic text data of the current encoded image area.

3. The image encoding method according to claim 2, wherein updating the semantic text data of the current encoded image area includes:
redividing the current encoded image area into a plurality of mutually independent sub- image areas;
converting the plurality of redivided mutually independent sub-image areas into a plurality of pieces of sub-semantic text data based on the first conversion module, wherein each piece of sub-semantic text data represents sub-semantics describing a corresponding sub-image area; and
determining the plurality of pieces of sub-semantic text data as the semantic text data of the current encoded image area.

4. The image encoding method according to claim 2, wherein updating the semantic text data of the current encoded image area includes:
determining a neighboring area of the current encoded image area and modifying a semantic text of the current encoded image area based on semantic text data of the neighboring area; or
regenerating the semantic text data of the current encoded image area based on a second conversion module, wherein the second conversion module has different model parameters from the first conversion module.

5. The image encoding method according to claim 1, wherein the preset division mode includes:
a first mode, the plurality of image areas being mutually independent areas in the first mode;
a second mode, in the second mode, the plurality of image areas including a first area and a second area, and the first area including the second area; and
a third mode, in the third mode, the plurality of image areas including a first area and a second area, and the first area and the second area partially overlapping.

6. The image encoding method according to claim 5, wherein converting the plurality of image areas into the plurality of pieces of semantic text data based on the first conversion module includes:
for different division modes, converting, by the first conversion module, the plurality of image areas into semantic text data of a corresponding mode, and reconstructing an image of the corresponding mode based on the semantic text data of each corresponding mode;
determining differences between reconstructed images of corresponding modes and the input image; and
packaging semantic text data of a mode corresponding to a smallest difference of the modes to generate the encoded data of the input image.

7. The image encoding method according to claim 1, further comprising, before dividing the input image:
identifying a type of the input image; and
selecting a conversion module matching the type of the input image from a plurality of conversion modules based on the type of the input image, wherein each conversion module corresponds to an image-to-text model.

8. The image encoding method according to claim 3, further comprising:
in response to a number of times for updating the semantic text data of the current encoded image area exceeding a preset threshold, encoding the current encoded image area into a corresponding data stream in an entropy encoding method; and
embedding the data stream into the encoded data of the input image.

9. A decoding method comprising:
obtaining encoded data of an input image, wherein the encoded data includes a plurality of pieces of semantic text data corresponding to a plurality of image areas;
converting the plurality of pieces of semantic text data into a plurality of pieces of image area data corresponding to the plurality of image areas based on a third conversion module; and
combining the plurality of pieces of image area data to obtain decoded input image data.

10. The decoding method according to claim 9, further comprising:
identifying an image type of the decoded input image data, and selecting a conversion module matching the image type from a plurality of conversion modules based on the image type, wherein each conversion module corresponds to a text-to-image model.

11. An electronic device comprising:
one or more processors; and
one or more memories storing a program that, when executed by the one or more processors, causes the one or more processors to:
divide an input image into a plurality of image areas according to a preset division mode;
convert the plurality of image areas into a plurality of pieces of semantic text data based on a first conversion module, wherein each piece of semantic text data represents semantics describing a corresponding image area; and
package the plurality of pieces of semantic text data to generate encoded data of the input image.

12. The electronic device according to claim 11, wherein the one or more processors are further configured to:
reconstruct the image areas based on the plurality of pieces of semantic text data;
determine a current encoded image area; and
in response to a difference between the current encoded image area and a corresponding reconstructed image area exceeding a preset metric threshold, update the semantic text data of the current encoded image area.

13. The electronic device according to claim 12, wherein the one or more processors are further configured to:
redivide the current encoded image area into a plurality of mutually independent sub- image areas;
convert the plurality of redivided mutually independent sub-image areas into a plurality of pieces of sub-semantic text data based on the first conversion module, wherein each piece of sub-semantic text data represents sub-semantics describing a corresponding sub-image area; and
determine the plurality of pieces of sub-semantic text data as the semantic text data of the current encoded image area.

14. The electronic device encoding method according to claim 12, wherein the one or more processors are further configured to:
determine a neighboring area of the current encoded image area and modify a semantic text of the current encoded image area based on semantic text data of the neighboring area; or
regenerate the semantic text data of the current encoded image area based on a second conversion module, wherein the second conversion module has different model parameters from the first conversion module.

15. The electronic device according to claim 11, wherein the preset division mode includes:
a first mode, the plurality of image areas being mutually independent areas in the first mode;
a second mode, in the second mode, the plurality of image areas including a first area and a second area, and the first area including the second area; and
a third mode, in the third mode, the plurality of image areas including a first area and a second area, and the first area and the second area partially overlapping.

16. The electronic device according to claim 15, wherein the one or more processors are further configured to:
for different division modes, convert, by the first conversion module, the plurality of image areas into semantic text data of a corresponding mode, and reconstructing an image of the corresponding mode based on the semantic text data of each corresponding mode;
determine differences between reconstructed images of corresponding modes and the input image; and
package semantic text data of a mode corresponding to a smallest difference of the modes to generate the encoded data of the input image.

17. The electronic device according to claim 11, wherein the one or more processors are further configured to, before dividing the input image:
identify a type of the input image; and
select a conversion module matching the type of the input image from a plurality of conversion modules based on the type of the input image, wherein each conversion module corresponds to an image-to-text model.

18. The electronic device according to claim 13, wherein the one or more processors are further configured to:
in response to a number of times for updating the semantic text data of the current encoded image area exceeding a preset threshold, encode the current encoded image area into a corresponding data stream in an entropy encoding method; and
embed the data stream into the encoded data of the input image.
